(19) United States
(12) Patent Application Publication
(10) Pub. No.: US 2004/0086595 A1
(43) Pub. Date: May 6, 2004

(54) Plasticized prolamine compositions

(76) Inventors: Jingping Liu, Highland Park, NJ (US); Willy Weisheng Lee, Bridgewater, NJ (US)

Correspondence Address: BELL, BOYD & LLOYD LLC, P.O. Box 1135, Chicago, IL, 60690-1135, US

(21) Appl. No.: 10/284,945

(22) Filed: Oct. 31, 2002

(51) Int. Cl. A23G 3/30

(52) U.S. Cl. 426/3

(57) ABSTRACT

Prolamine compositions, blends, mixtures, films, products thereof and methods of preparing and using same are provided. The prolamine compositions of the present invention include prolamine, such as zein, in combination with a one or more suitable medium chain fatty acids, such as C₆ to C₁₄ fatty acids and/or their monoglycerides thereof which can be useful as softeners for prolamines. The medium chain fatty acids include, for example, caproic acid, caprylic acid, capric acid, lauric acid, or combinations thereof. The plasticized and softened prolamines of the present invention can be used to make a variety of different types of biodegradable and/or edible products, such as gum bases, chewing gums, packaging films, coatings, adhesives, encapsulants for drug, flavor, sweetener, delivery, or the like.

### BACKGROUND OF THE INVENTION

The present invention relates to prolamine compositions. More specifically, the present invention relates to plasticized prolamine compositions that are edible and/or biodegradable.

For certain applications, prolamines have been used in consumer products. For example, zein is a water-insoluble prolamine obtained from corn that is edible and readily biodegradable as an ingredient. Accordingly, zein is a very attractive material for use in food applications. Additionally, zein has been used in industrial applications. In this regard, zein has been employed in packaging films, coatings, and adhesives.

However, zein is a very brittle plastic material at ambient temperature. Its glass transition temperature is in the range of 136° C.-140° C. In view of same, zein is usually used in the form of either a fine powder or in solution with alcohol and water. This can create processing difficulties that limit the application of zein.

In food products, due to its desirable characteristics, there have been attempts of using zein in making chewing gums. In this regard, zein has desirable nutritional and biodegradable properties. Further, as applied to gum, for example, the fact that zein becomes brittle after it loses moisture is an advantageous property. This feature can ease the removal of zein-containing gum cuds from substrates.

A number of patents disclose the use of zein in gums including chewing gums. See, U.S. Pat. Nos. 2,154,482; 2,489,147; 5,482,722; 5,139,794; 3,116,206; 5,112,625; 4,863,745; 4,931,295; 5,367,055; 5,482,722; 4,753,790; 4,474,749; 5,409,715; 5,433,960; 5,882,702; and non-U.S. patents and published applications: JP95-163300; German Patent DE3043914A1; International Patent Publication Nos. WO90/12512; WO90/06061; and WO89/09594. U.S. Pat. Nos. 5,325,351; 5,367,055; 5,342,923; 5,324,351; and 6,020,008 also disclose the use of zein.

However, due to processing difficulties and other issues with the current methods of processing zein, the use of zein in chewing gums, as well as other food-grade and ecofriendly products and industrial applications, has been problematic.

A need, therefore, exits to provide improved prolamine compositions and methods of producing and using same.

### SUMMARY OF THE INVENTION

The present invention provides prolamine compositions and processes for making and using same. The prolamine compositions can be utilized in a variety of applications, such as in blends and/or mixtures used in a variety of suitable products including, for example, edible products, biodegradable products, gum bases, chewing gums, packaging films, coatings, adhesives, and encapsulants for drugs, flavor and sweeteners, or other like products.

The prolamine compositions of the present invention can be made from a variety of different and suitable materials. In an embodiment, the prolamine compositions include an alcohol-soluble protein, such as zein, corn gluten meal, wheat gluten, wheat gliadin, secalinin, avenin, hordein, panicin, orzenin, kafirin, the like or combinations thereof. The compositions also include a plasticizer which can facilitate processing of the prolamine composition. In an embodiment, the plasticizer includes one or more medium chain fatty acids, and their monoglycerides. The medium chain fatty acids can include a number of different and suitable types of C₆ to C₁₄ fatty acids including, for example, caproic acid, caprylic acid, capric acid, lauric acid, the like, monoglycerides thereof or combinations thereof.

In an embodiment, the present invention provides a miscible blend. The miscible blend includes at least one prolamine and at least one medium chain fatty acid.

In another embodiment, the present invention provides a gum base. The gum base includes a material blend including at least one prolamine and at least one medium chain fatty acid.

In yet another embodiment of the present invention, a process of producing a prolamine composition is provided. The process includes the steps of dissolving a prolamine in a solution including alcohol and water to form a prolamine solution; adding at least one medium chain fatty acid or its monoglyceride to the prolamine solution; and drying the prolamine solution to form the prolamine composition.

In still yet another embodiment of the present invention, a process of producing a prolamine composition is provided. The process includes the steps of mixing prolamine with an effective amount of at least one medium chain fatty acid in a mixing device.

In a further embodiment of the present invention, a process of producing a gum is provided. The process includes the steps of providing a plurality of gum ingredients including a gum base and a flavor wherein the gum base includes a blend of at least one prolamine and at least one medium chain fatty acid or its monoglyceride; and processing the gum ingredients to form the gum.

An advantage of the present invention is to provide improved prolamine compositions and methods of making and using same.

Another advantage of the present invention is to provide a more usable form of zein with properties ranging from, for example, pasty adhesives, to rubbery chewing gum bases, to tough packaging films.

Yet another advantage of the present invention is to provide improved methods for incorporating a prolamine in an edible and biodegradable product.

Yet still another advantage of the present invention is to provide improved processes for making miscible mixtures or blends including prolamine.

A further advantage of the present invention is to provide improved gum products that includes the prolamine compositions of the present invention.

A still further advantage of the present invention is to provide improved edible and/or biodegradable products that include the prolamine.

Additional features and advantages of the present invention are described in, and will be apparent from, the following Detailed Description of the Invention.

### DETAILED DESCRIPTION OF THE INVENTION

The present invention generally relates to prolamine compositions. More specifically, the present invention relates to plasticized prolamine mixtures or blends, processes for making and using same, and products made therefrom. The prolamine compositions of the present invention can include a variety of suitable materials. In general, the prolamine composition includes a prolamine component and a plasticizer. The prolamine component includes, for example, zein, wheat gluten, or the like.

Prolamine is an alcohol-soluble protein. Prolamine is one of the primary proteins in all cereals. Examples include zein (from corn), gliadin (from wheat), the like or combinations thereof. Less pure versions include corn gluten meal, wheat gluten, the like or combinations thereof. These types of prolamine have a number of desirable characteristics. For example, these and other similar types of prolamine are readily edible as food ingredients. Also, such types of prolamine are readily biodegradable. This makes them attractive as engineering materials as applied to a number of suitable types of products and applications thereof including, for example, packaging, coatings, adhesives, encapsulation, the like or combinations thereof.

However, pure zein and gliadin are very brittle plastic materials at ambient conditions. Whether a material is hard or rubbery at ambient conditions is characterized by its glass transition temperature (Tg). For a non-crystalline material, if its Tg is lower than ambient temperature, it should be rubbery. Otherwise, it should be hard at ambient conditions. In this regard, both zein and gliadin have a much higher Tg than ambient temperature, thus these types of prolamine are hard and brittle at ambient conditions. Due to same, zein and gliadin are typically used in the form of either a fine powder or in a solution that includes alcohol and water. This can limit the applications and uses of zein, corn gluten meal, wheat gluten, wheat gliadin and/or the like.

As the primary component of the corn proteins, zein has peptide groups (—CO—HN—CHR—) in the main chain as all other proteins. Zein is composed of more than 50% nonpolar amino acid residues, such as leucine, isoleucine, valine, alanine, phenylalanine, glycine, the like or combinations thereof, as the branches along the main chain of zein. In addition, zein is rich in glutamine. The uncharged polar terminal group of glutamine promotes protein associated by hydrogen bonding. Such structure makes zein insoluble in water at a neutral pH but highly swellable. Currently, known and effective plasticizers include, for example, propylene glycol, ethylene glycol, acetic acid, lactic acid, poly(propylene glycol), poly(ethylene glycol), glycerol, ethanol, fatty acids, the like or combinations thereof.

As previously discussed, the prolamine compositions include one or more plasticizers. In general, the plasticizer is positioned between the macromolecular chains of a prolamine macromolecule, such as zein macromolecules, and remains in place-due to intermolecular interactions. This is accomplished best when the attractions between the molecules of both components are similar. If the attractions are sufficiently different, the strongly attracted molecules will cling together, and immiscibility will result. The attraction forces between molecules include dispersion force, polar force and hydrogen bonding. It is well known that the ionic force and hydrogen bonding play critical roles in most protein dissolution in aqueous solutions. In non-aqueous media, the hydrogen bonding tends to become the major driving force to form miscible blends between zein and the plasticizers. In one aspect, the plasticizers are required to possess sufficient electron donor and acceptor properties in the structures in order to form effective hydrogen bonding with zein macromolecules. In another aspect, the proper balance of hydrophobic and hydrophilic portions in their molecular structures is also essential due to the amphiphilic property of prolamine molecules.

Medium chain fatty acids, such as C₆ to C₁₄ fatty acids and their monoglycerides, include both electron donors (e.g., oxygen in >C═O) and electron acceptors (e.g., hydrogen or proton in O═C—OH and —OH). In this regard, medium chain fatty acids are considered to be amphiphilic due to the coexistence of a hydrocarbon chain and the polar carboxyl groups attached thereto.

The inventors have found that prolamines, such as zein, can be effectively plasticized by medium chain fatty acids and their monoglycerides. This can facilitate the processing and use of same. In an embodiment, the medium chain fatty acids include C₆ to C₁₄ fatty acids, their monoglycerides thereof or combinations thereof. The C₆ to C₁₄ fatty acids of the present invention can include, for example, caproic acid, caprylic acid, capric acid, lauric acid, their monoglycerides thereof, the like or combinations thereof. In an embodiment, caproic acid, caprylic acid, capric acid, their monoglycerides thereof or combinations thereof are preferred. In the presence of the monoglycerides of medium chain fatty acids, the processing temperature of zein can be decreased well-below the zein decomposition temperature. This thermal processability allows the blends to be readily incorporated into edible and/or biodegradable products, such as gums, gum bases and/or the like.

As used herein, the term “edible product” or like terms is intended to broadly refer to any product that is suitable for consumption by a mammal, preferably human. An edible product can include, but is not limited to, foodstuffs, confections, chewing gums, capsules for medicament delivery, component parts thereof and the like. As used herein, the term “biodegradable product” or like terms is intended to broadly refer to any product or substance that can be chemically degraded by natural factors, such as soil bacteria, weather, plants, animals, the like or combinations thereof.

Further, it has been found that the mechanical properties of the plasticized prolamine blends can be modified or altered to exhibit a number of different properties ranging from a tacky state to a brittle state. The mechanical properties can be modified in a number of different ways. For example, the properties can be modified by varying the amount and type of medium chain fatty acids and their monoglycerides thereof.

The present invention can include any suitable amount of prolamine. In an embodiment, the amount of prolamine includes about 5% to about 99.5% by weight of the composition, product, mixture, blend or the like. In an embodiment, a prolamine content ranging from about 20% by weight to about 95% by weight is preferred.

The compositions, products, mixtures and blends of the present invention can include medium chain fatty acids and their monoglycerides thereof in any suitable amount. In an embodiment, the amount of medium chain fatty acids and their monoglycerides thereof ranges from about 0.5% to about 80% by weight of the composition, product, mixture, blend or the like. In an embodiment, the amount of medium chain fatty acids and their monoglycerides thereof includes about 5% by weight to about 30% by weight.

As previously discussed, the present invention provides a process of making miscible prolamine blends. In an embodiment, the process includes dissolving an effective amount of prolamine in solution containing alcohol and water to form a prolamine solution; adding an effective amount of a medium chain fatty acid and/or their monoglyceride thereof to the prolamine solution; and drying the prolamine solution to remove solvents therefrom.

The process of the present invention can include a variety of suitable components and be subject to a variety of suitable and different process conditions. For example, the alcohol component can include a variety suitable types of low and high molecular weight linear or branched alcohols. In an embodiment, the alcohols include methanol, ethanol, propanol, butanol, the like or combinations thereof.

It should be appreciated that the miscible prolamine blends of the present invention can be made in a variety of suitable ways in addition to the process procedures and conditions discussed above. For example, the process in an embodiment can include adding an effective amount of prolamine to a heated sigma-blade mixer or the like. An effective amount of the medium chain fatty acid or its monoglyceride is then added to the prolamine. Water can be optionally added to serve as a co-plasticizer. The blend of prolamine and medium chain fatty acid is mixed until it is homogeneous. The blend is then discharged from the mixer. The process can be modified in a number of suitable ways. For example, this can also be done in a continuous mixer, such as an extruder. Other suitable ingredients, such as colorant, preservative, filler, the like, or combinations thereof can also be added.

In an embodiment, the process of the present invention results in a prolamine blend that is in a solid form, such as powder, pellet, slates, the like or combinations thereof. If desired, the blend may be dissolved in solution, such as with an alcohol solution.

As previously discussed, the prolamine-based compositions of the present invention can be used to make a variety of different and suitable products including edible and/or biodegradable products. In an embodiment, the blended compositions of the present invention can be utilized in chewing gum bases and chewing gums. In this regard, such prolamine compositions are useful in chewing gums, because of their elasticity. Moreover, because of their potential biodegradability, such compositions provide an environmentally friendly alternative to conventional gums. Moreover, as the basic component of such compositions is prolamine, these gums can be potentially ingestible and digestible.

Chewing gums, generally consist of a water insoluble gum base, a water soluble sweetener, and flavors. The insoluble gum base generally includes elastomers, resins, fats and oils, softeners, and inorganic fillers. The prolamine compositions of the present invention can form ingestible elastomer substances. In order to produce an environmentally-friendly gum base, the plasticized prolamine elastomer can be further combined with other ingestible ingredients that may include polysaccharides, proteins or hydrolysates thereof, ingestible emulsifiers, lipids and the like. Polysaccharides may include native starches, modified starches, dextrins, maltodextrin, hydroxypropylmethylcellulose, dietary fibers, pectins, alginates, carrageenan, gellan gum, xanthan gum, gum arabic, guar gum or other natural gums and the like. The preferred polysaccharides are maltodextrin and high-conversion dextrins. Preferably, the gum bases include about 5% to about 10% by weight polysaccharides. Among digestible proteins, hydrolyzed collagens or gelatins are preferred. In an embodiment, the content is about 10% to about 20% by weight in the base.

The gum base can also include fillers and optional minor amounts of ingredients such as colorants, preservatives, the like or combinations thereof. Fillers/texturizers may include magnesium and calcium carbonate, ground limestone, silicate types such as magnesium and aluminum silicate, clay, alumina, talc, titanium oxide, mono-, di- and tricalcium phosphate, cellulose polymers, such as wood, and combinations thereof.

Colorants and whiteners may include FD&C-type dyes and lakes, fruit and vegetable extracts, titanium dioxide, and combinations thereof.

The base may or may not include wax. An example of a wax-free gum base is disclosed in U.S. Pat. No. 5,286,500, the disclosure of which is incorporated herein by reference.

In addition to a water insoluble gum base portion, a typical chewing gum composition includes a water soluble bulk portion and one or more flavoring agents. The water soluble portion can include bulk sweeteners, and high intensity sweeteners.

Bulk sweeteners include both sugar and sugarless components. Bulk sweeteners typically constitute 5 to about 95% by weight of the gum, more typically, 20% to 80% by weight, and more commonly, 30% to 60% by weight of the gum.

Sugar sweeteners generally include saccharide-containing components commonly known in the gum art, including, but not limited to, sucrose, dextrose, maltose, dextrin, dried invert sugar, fructose, levulose, galactose, corn syrup solids, and the like, alone or in combination.

Sorbitol can be used as a sugarless sweetener. Additionally, sugarless sweeteners can include, but are not limited to, mannitol, xylitol, hydrogenated starch hydrolysates, maltitol, lactitol, and the like, alone or in combination.

High intensity artificial sweeteners can also be used in combination with the above. Preferred sweeteners include, but are not limited to sucralose, aspartame, salts of acesulfame, alitame, saccharin and its salts, cyclamic acid and its salts, glycyrrhizin, dihydrochalcones, thaumatin, monellin, and the like, alone or in combination. In order to provide longer lasting sweetness and flavor perception, it may be desirable to encapsulate or otherwise control the release of at least a portion of the artificial sweetener. Such techniques as wet granulation, wax granulation, spray drying, spray chilling, fluid bed coating, coacervation, and fiber extension may be used to achieve the desired release characteristics.

Usage level of the artificial sweeteners will vary greatly and will depend on such factors as potency of the sweetener, rate of release, desired sweetness of the product, level and type of flavor used and cost considerations. Thus, the active level of artificial sweetener may vary from 0.02% to about 8%. When carriers used for encapsulation are included, the usage level of the encapsulated sweetener will be proportionately higher.

Combinations of sugar and/or sugarless sweeteners may be used in gums of the present invention.

If a low calorie gum is desired, a low caloric bulking agent can be used. Example of low caloric bulking agents include: polydextrose; Raftilose, Raftilin; Fructooligosaccarides (NutraFlora); Palatinose oligosaccharide; Guar Gum Hydrolysate (Sun Fiber); or indegestible dextrin (Fibersol). However, other low calorie bulking agents can be used.

A variety of flavoring agents can be used. The flavor can be used in amounts of about 0.1 weight percent to about 15 weight percent of the gum and, preferably about 0.2% to about 5% by weight. Flavoring agents may include essential oils, synthetic flavors or mixtures thereof including, but not limited to, oils derived from plants and fruits such as citrus oils, fruit essences, peppermint oil, spearmint oil, other mint oils, clove oil, oil of wintergreen, anise and the like. Artificial flavoring agents and components may also be used. Natural and artificial flavoring agents may be combined in any sensorially acceptable fashion.

By way of example and not limitation, the present invention according to an embodiment is described below:

### EXAMPLE 1

### Preparing Zein Solution

Zein (Freeman Industries, Inc., Regular grade) was dissolved in a 70 wt % isopropanol (30% water) mixture to form a 10% solution (10 grams zein +90 grams solvents).

### EXAMPLE 2

### Preparing a Pure Zein Film

A film was cast from 10 grams of Example 1 solution onto a flat-bottom dish with a diameter of 60 mm. It was allowed to dry at ambient conditions for 48 hours, then under vacuum (5 mm Hg) at ambient temperature for 8 hours. The film was clear yet brittle.

### EXAMPLE 3

### Solution Blending

Caproic acid (Spectrum Quality Products, Inc.) was dissolved in Example 1 at a ratio of 1:10 by weight. A film was cast from 10 grams of such solution onto a flat-bottom dish with a diameter of 60 mm. It was allowed to dry at ambient conditions for 48 hours, then under vacuum (5 mm Hg) at ambient temperature for 8 hours. The film was clear and tough, suggesting good miscibility. It should theoretically contain 1 part of caproic acid for each part of zein.

### EXAMPLE 4

### Solution Blending

Caprylic acid (Spectrum Quality Products, Inc.) was dissolved in Example 1 at a ratio of 1:10 by weight. A film was cast from 10 grams of such solution onto a flat-bottom dish with a diameter of 60 mm. It was allowed to dry at ambient conditions for 48 hours, then under vacuum (5 mm Hg) at ambient temperature for 8 hours. The film is clear and tough, suggesting good miscibility. It should theoretically contain 1 part of caprylic acid for each part of zein.

### EXAMPLE 5

### Solution Blending

Capric acid (Spectrum Quality Products, Inc.) was dissolved in Example 1 at a ratio of 1:10 by weight. A film was cast from 10 grams of such solution onto a flat-bottom dish with a diameter of 60 mm. It was allowed to dry at ambient conditions for 48 hours, then under vacuum (5 mm Hg) at ambient temperature for 8 hours. The film was clear and tough, suggesting good miscibility. It should theoretically contain equal parts of capric acid and zein.

### EXAMPLE 6

### Solution Blending

Monoglyceride of caprylic acid (Sasol North America, Inc.) was dissolved in Example 1 at a ratio of 1:20 by weight. A film was cast from 10 grams of such solution onto a flat-bottom dish with a diameter of 60 mm. It was allowed to dry at ambient for conditions 48 hours, then under vacuum (5 mm Hg) at ambient temperature for 8 hours. The film was clear and soft, suggesting good miscibility. It should theoretically contain 1 part Monoglyceride of caprylic acid for every 2 parts of zein.

### EXAMPLE 7

### Solution Blending

Monoglyceride of capric acid (Danisco Corporation) was dissolved in Example 1 at a ratio of 1:20 by weight. A film was cast from 10 grams of such solution onto a flat-bottom dish with a diameter of 60 mm. It was allowed to dry at ambient conditions for 48 hours, then under vacuum (5 mm Hg) at ambient temperature for 8 hours. The film is clear and soft, suggesting good miscibility. It should theoretically contain 1 part Monoglyceride of caprylic acid for every 2 part of zein.

### EXAMPLE 8

### Direct Blending

To a Sigma-blade laboratory mixer (Plasti-Corder Digi-System, C. W. Brabender Instruments Inc., South Hackensack, N.J.), 30 grams of zein were added, and then 6 grams of monoglyceride of caprylic acid, 3 grams of monoglyceride of capric acid and 15 grams of water were added during agitation. The mixer was set at 50° C. and 52 rpm. After mixed for 20 minutes, the blend was discharged. It was soft, elastic, and translucent, indicating good miscibility.

### EXAMPLE 9

### Preparing a Chewing Gum

To the Brabender mixer set at 60° C. and 52 rpm, 54 grams of zein/monoglyceride of caprylic acid blend prepared in Example 8 were added and agitated for 10 minutes. Then 50 grams of mannitol, 2 grams of acesulfame K and 0.5 g aspartame were added. After 10 more minutes of further mixing, 0.5 grams menthol powder and 2.0 ml peppermint flavor were added and mixed for another 10 minutes. Then the gum was discharged, rolled to a sheet, and cut into gum cube. It has soft, pliable, and lasting chewing texture like a conventional chewing gum.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A miscible blend comprising at least one prolamine and at least one medium chain fatty acid.

2. The miscible blend of claim 1 wherein the miscible blend is biodegradable.

3. The miscible blend of claim 1 wherein the miscible blend is edible.

4. The miscible blend of claim 1 wherein the prolamine is selected from the group consisting of zein, corn gluten meal, wheat gluten, wheat gliadin, secalinin, avenin, hordein, panicin, orzenin, kafirin and combinations thereof.

5. The miscible blend of claim 1 wherein the prolamine ranges from about 5% to about 99.5% by weight of the miscible blend.

6. The miscible blend of claim 1 wherein the medium chain fatty acid ranges from about 0.5% by weight to about 95% by weight of the miscible blend.

7. The miscible blend of claim 1 wherein the medium chain fatty acid is selected from the group consisting of C₆ to C₁₄ fatty acids and combinations thereof.

8. The miscible blend of claim 1 wherein the medium chain fatty acid is selected from the group consisting of caproic acid, caprylic acid, capric acid, lauric acid, and combinations thereof.

9. A miscible blend comprising at least one prolamine and at least one monoglyceride of a medium chain fatty acid.

10. The miscible blend of claim 9 wherein the miscible blend is biodegradable.

11. The miscible blend of claim 9 wherein the miscible blend is edible.

12. The miscible blend of claim 9 wherein the prolamine is selected from the group consisting of zein, corn gluten meal, wheat gluten, wheat gliadin, secalinin, avenin, hordein, panicin, orzenin, kafirin and combinations thereof.

13. The miscible blend of claim 9 wherein the prolamine ranges from about 5% to about 99.5% by weight of the miscible blend.

14. The miscible blend of claim 9 wherein the monoglyceride ranges from about 0.5% to about 95% by weight of the miscible blend.

15. The miscible blend of claim 9 wherein the medium chain fatty acid is selected from the group consisting of C₆ to C₁₄ fatty acids and combinations thereof.

16. The miscible blend of claim 9 wherein the medium chain fatty acid is selected from the group consisting of caproic acid, caprylic acid, capric acid, lauric acid, and combinations thereof.

17. A gum base comprising a material blend including at least one prolamine and at least one medium chain fatty acid.

18. The gum base of claim 17 wherein the prolamine is selected from the group consisting of zein, corn gluten meal, wheat gluten, wheat gliadin, secalinin, avenin, hordein, panicin, orzenin, kafirin and combinations thereof.

19. The gum base of claim 17 wherein the prolamine ranges from about 5% to about 99.5% by weight of the gum base.

20. The gum base of claim 17 wherein the medium chain fatty acid ranges from about 0.5% by weight to about 95% by weight of the gum base.

21. The gum base of claim 17 wherein the gum base is incorporated in a gum.

22. The gum base of claim 17 wherein the medium chain fatty acid is selected from the group consisting of C₆ to C₁₄ fatty acids including caproic acid, caprylic acid, capric acid, lauric acid, and combinations thereof.

23. A gum base comprising a material blend including at least one prolamine and at least one monoglyceride of a medium chain fatty acid.

24. The gum base of claim 23 wherein the gum base is incorporated in a gum.

25. The gum base of claim 23 wherein the medium chain fatty acid is selected from the group consisting of C₆ to C₁₄ fatty acids including caproic acid, caprylic acid, capric acid, lauric acid, and combinations thereof.

26. A process of producing a prolamine composition, the process comprising the steps of:
dissolving a prolamine in a solution including alcohol and water to form a prolamine solution;
adding at least one medium chain fatty acid or monoglyceride thereof to the prolamine solution; and
drying the prolamine solution to form the prolamine composition.

27. The process of claim 26 wherein the prolamine solution is further processed by casting same into a film.

28. The process of claim 26, wherein the prolamine composition is processed to produce an edible product selected from the group consisting of films, miscible blends, chewing gums, chewing gum bases, adhesives, coatings, films, encapsulants including flavor encapsulants, sweetener encapsulants, and drug encapsulants, and combinations thereof.

29. The process of claim 26, wherein the prolamine composition is processed to produce a biodegradable product selected from the group consisting of miscible blends, chewing gums, chewing gum bases, adhesives, coatings, films, encapsulants including flavor encapsulants, sweetener encapsulants, and drug encapsulants, and combinations thereof.

30. The process of claim 26 wherein the prolamine is selected from the group consisting of zein, corn gluten meal, wheat gluten, wheat gliadin, secalinin, avenin, hordein, panicin, orzenin, kafirin and combinations thereof.

31. The process of claim 26 wherein the prolamine ranges from about 5% to about 99.5% by weight of prolamine composition.

32. The process of claim 26 wherein the medium chain fatty acid and monoglyceride thereof range from about 0.5% by weight to about 95% by weight of the prolamine composition.

33. The process of claim 26 wherein the medium chain fatty acid is selected from the group consisting of C₆ to C₁₄ fatty acids including caproic acid, caprylic acid, capric acid, lauric acid, and combinations thereof.

34. A process of producing a prolamine composition, the process comprising the steps of:
providing a prolamine; and
mixing the prolamine with an effective amount of at least one medium chain fatty acid or monoglyceride thereof in a mixing device.

35. The process of claim 34 wherein an effective amount of water is added during mixing of the prolamine and the medium chain fatty acid or monoglyceride thereof.

36. The process of claim 34 wherein the mixing device is selected from the group consisting of batch mixers and continuous extruders.

37. The process of claim 34, wherein the prolamine composition is processed to produce edible products selected from the group consisting of chewing gums, chewing gum bases, adhesives, coatings, films, encapsulants including flavor encapsulants, sweetener encapsulants, and drug encapsulants, and combinations thereof.

38. The process of claim 34, wherein the prolamine composition is processed to produce biodegradable products selected from the group consisting of chewing gums, chewing gum bases, adhesives, coatings, films, encapsulants including flavor encapsulants, sweetener encapsulants, and drug encapsulants, and combinations thereof.

39. The process of claim 34 wherein the prolamine is selected from the group consisting of zein, corn gluten meal, wheat gluten, wheat gliadin, secalinin, avenin, hordein, panicin, orzenin, kafirin and combinations thereof.

40. The process of claim 34 wherein the prolamine ranges from about 5% to about 99.5% by weight of the prolamine composition.

41. The process of claim 34 wherein the medium chain fatty acid and monoglyceride thereof range from about 0.5% by weight to about 95% by weight of the prolamine composition.

42. The process of claim 34 wherein the medium chain fatty acid is selected from the group consisting of C₆ to C₄ fatty acids including caproic acid, including caprylic acid, capric acid, lauric acid, and combinations thereof.

43. A process of producing a chewing gum, the process comprising the steps of:
providing a plurality of gum ingredients including a gum base and a flavor wherein the gum base includes a blend of at least one prolamine and at least one medium chain fatty acid or monoglyceride thereof; and
processing the gum ingredients to form the chewing gum.

44. The process of claim 43 wherein the prolamine is selected from the group consisting of zein, corn gluten meal, wheat gluten, wheat gliadin, secalinin, avenin, hordein, panicin, orzenin, kafirin and combinations thereof.

45. The process of claim 43 wherein the prolamine ranges from about 5% to about 99.5% by weight of the prolamine composition.

46. The process of claim 43 wherein the medium chain fatty acid or monoglyceride thereof ranges from about 0.5% by weight to about 95% by weight of the prolamine composition.

47. The process of claim 43 wherein the medium chain fatty acid is selected from the group consisting of C₆ to C₁₄ fatty acids including caproic acid, caprylic acid, capric acid, lauric acid and combinations thereof.
